(19) United States
(12) Patent Application Publication
(10) Pub. No.: US 2025/0091834 A1
(43) Pub. Date: Mar. 20, 2025

(54) STACKING APPARATUS AND IMAGE FORMING APPARATUS

(71) Applicant: CANON KABUSHIKI KAISHA, Tokyo (JP)

(72) Inventor: RYOICHI KAWASUMI, Ibaraki (JP)

(21) Appl. No.: 18/825,505

(22) Filed: Sep. 5, 2024

(30) Foreign Application Priority Data
Sep. 15, 2023 (JP) 2023-150142

(51) Int. Cl. B65H 31/12; G03G 15/00

(52) U.S. Cl. CPC B65H 31/12; G03G 15/6552

(57) ABSTRACT

A stacking apparatus includes: a stacking portion on which a sheet discharged by a discharge member is to be stacked; a tray including a placement surface on which the same sheet as the sheet stacked on the stacking portion is to be placed, wherein the tray is movable with respect to the stacking portion; and a holding portion configured to hold the tray in a first state and in a second state in which the tray is able to support the sheet. The placement surface of the tray in the first state is in a state of a vertical, or in a state closer to the vertical than the placement surface of the tray in the second state.

### BACKGROUND OF THE DISCLOSURE

### Field of the Disclosure

The present disclosure relates to a stacking apparatus on which sheets discharged by a discharge member are stacked, and to an image forming apparatus.

### Description of the Related Art

In general, an image forming apparatus, in which a discharge opening through which a sheet on which an image is formed is discharged is provided in a body of the image forming apparatus, is configured to have a width of around 600 mm. Such an image forming apparatus is intended and configured mainly to feed a sheet having a length of up to about 420 mm, form an image on the sheet, and discharge the sheet on which the image is formed through the discharge opening. Accordingly, a discharge tray provided in the body of the image forming apparatus is also configured to have a tray length that enables sheets each having a length of up to about 420 mm to be placed on the discharge tray. Thus, for example, when an image is formed on a so-called long sheet that exceeds 600 mm in length, a discharge tray dedicated for long sheets may be mounted to the image forming apparatus.

Here, Japanese Patent Application Laid-Open No. 2003-341907 discloses a conventional discharge tray unit that is used for an electrophotographic image forming apparatus and enables a long sheet on which an image is formed to be placed on the discharge tray unit. The discharge tray unit of Japanese Patent Application Laid-Open No. 2003-341907 is removably mounted to the discharge opening of the image forming apparatus and includes a curved guide portion that rotates and conveys a long sheet so as to be capable of receiving the long sheet having a length that exceeds a width of the image forming apparatus.

However, according to Japanese Patent Application Laid-Open No. 2003-341907, it is required to mount the dedicated discharge tray unit to the discharge opening each time an image is formed on a long sheet. This means that the discharge tray unit is required to be removed at a point in time when the image formation on the long sheet has been finished. As a result, there are such problems that the time and effort are required to mount and remove the dedicated discharge tray unit, and that it is required to secure a storage location for the removed dedicated discharge tray unit.

### SUMMARY OF THE DISCLOSURE

According to an embodiment of the present disclosure, a stacking apparatus includes a stacking portion on which a sheet discharged by a discharge member is to be stacked; a tray including a placement surface on which the same sheet as the sheet stacked on the stacking portion is to be placed, wherein the tray is movable with respect to the stacking portion; and a holding portion configured to hold the tray in a first state and in a second state in which the tray is able to support the sheet, wherein the placement surface of the tray in the first state is in a state of a vertical, or in a state closer to the vertical than the placement surface of the tray in the second state.

Further features of the present disclosure will become apparent from the following description of exemplary embodiments with reference to the attached drawings.

### BRIEF DESCRIPTION OF THE DRAWINGS

FIG. 1 is a sectional view of an image forming apparatus.

FIG. 2 is a sectional view of the image forming apparatus with a discharge tray unit mounted to a left side surface of the image forming apparatus.

FIG. 3 is a sectional view of the image forming apparatus with an extension tray stored in a storage housing.

FIG. 4 is a perspective view of the image forming apparatus.

FIG. 5 is a perspective view of the discharge tray unit.

FIG. 6 is a perspective view of the discharge tray unit as seen from an obliquely lower side thereof.

FIG. 7 is a perspective view of the extension tray.

FIG. 8A, FIG. 8B, and FIG. 8C are sectional views of the discharge tray unit.

FIG. 9 is a perspective view of a service book holder.

FIG. 10 is a sectional view of the image forming apparatus to which the service book holder is mounted.

FIG. 11 is a sectional view of the image forming apparatus to which the service book holder and the discharge tray unit are mounted.

### DESCRIPTION OF THE EMBODIMENTS

### (Image Forming Apparatus)

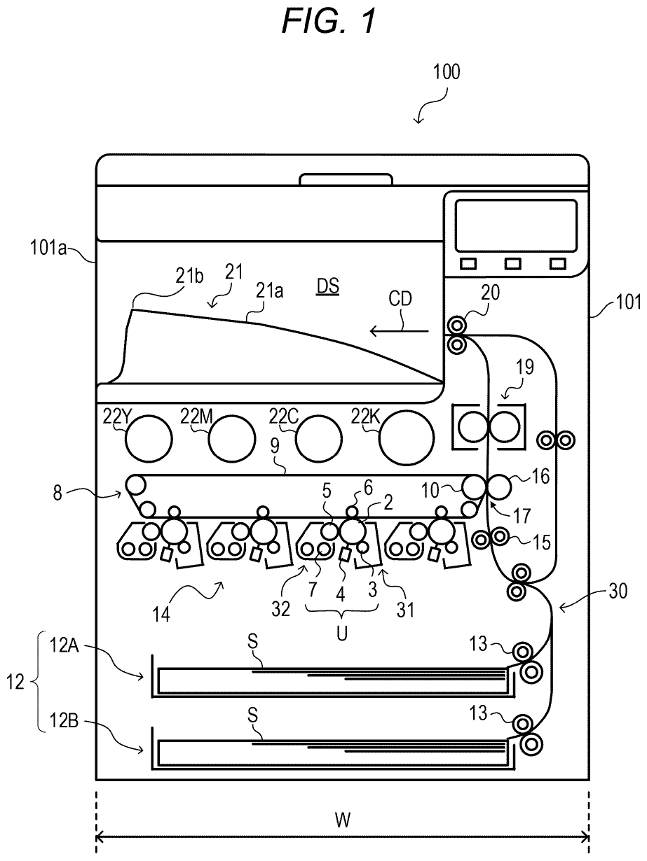

Now, an embodiment is described with reference to the drawings. FIG. 1 is a sectional view of an image forming apparatus 100. The image forming apparatus 100 is a 4-color full-color LED printer that adopts a tandem-type intermediate transfer method using an electrophotographic process. The image forming apparatus 100 forms an image on a sheet S as a recording medium with toner based on image information input from an external host apparatus (not shown) such as a personal computer to a control circuit unit (not shown). The image forming apparatus 100 includes an image forming portion 14 that forms an image on the sheet S. The image forming portion 14 is arranged at a substantially center portion of an apparatus main body 101. The image forming portion 14 includes four image forming units U that respectively form toner images of yellow (Y), magenta (M), cyan (C), and black (K) in the stated order from the left. The image forming units U that form toner images of respective colors are almost identical. To avoid complexity of the illustration, the image forming unit that forms the toner image of cyan (C) is representatively denoted by the reference symbol U, and indication of the image forming units for forming the toner images of other colors by the reference symbols is omitted.

The image forming unit U includes two replaceable and removable units, specifically, a drum unit 31 provided with a rotary-drum-type electrophotographic photosensitive member (hereinafter referred to as “drum”) 2 as an image bearing member, and a developing unit 32 provided with a developing sleeve 5 that develops a toner image. The drum unit 31 (drum cartridge) includes the drum 2, a charging roller 3 that charges the drum 2, and a drum cleaner (not shown) that removes the toner remaining on the drum 2. The developing unit 32 (developing cartridge) includes the developing sleeve 5 that develops an electrostatic latent image formed on the drum 2 with toner, and a screw 7 that supplies toner to the developing sleeve 5 and agitates the toner. Here, inside the developing unit 32, the toner is circulated and conveyed at high speed by the screw 7. A rotation speed of the screw 7 is extremely high relative to a rotation speed of the developing sleeve 5 or a rotation speed of the drum 2. A high voltage is applied to the developing sleeve 5 via a path different from that for the charging roller 3. The electrically charged toner inside the developing unit 32 is agitated by the screw 7 and evenly coated on the developing sleeve 5. A light-emitting diode (LED) exposure unit 4 including LED light-emitting elements is arranged between the drum unit 31 and the developing unit 32.

Above the four image forming units U, an intermediate transfer belt unit 8 is arranged. The intermediate transfer belt unit 8 includes four primary transfer rollers 6, which are arranged so as to be opposed to the drums 2 of respective colors, respectively, and a belt 9. Below the four image forming units U, a sheet cassette 12 is arranged. The sheet cassette 12 includes two sheet cassettes, specifically, a sheet cassette 12A located on the upper level, and a sheet cassette 12B located on the lower level. Above the intermediate transfer belt unit 8, toner bottles 22Y, 22M, 22C, and 22K, which contain toners to be supplied to the developing sleeves 5 of the four image forming units U, respectively, are removably mounted to the apparatus main body 101. A toner supply mechanism (not shown) supplies an appropriate amount of toner at the appropriate time from the toner bottles 22Y, 22M, 22C, and 22K to the corresponding developing sleeves 5.

### (Image Forming Process)

An image forming process of the image forming apparatus 100 is described below. The same image forming process is carried out in the four image forming units U. In FIG. 1, the drum 2 is rotated clockwise. The charging roller 3 is brought into press contact with the rotating drum 2 and applied with a high voltage to uniformly charge a surface of the drum 2. The LED exposure unit 4, which is arranged between the drum unit 31 and the developing unit 32, radiates light from the LED light-emitting elements onto the uniformly charged surface of the drum 2 in accordance with an image signal to form an electrostatic latent image on the surface of the drum 2. The developing sleeve 5 develops the electrostatic latent image on the surface of the drum 2 with toner into a toner image.

In FIG. 1, the belt 9 being an intermediate transfer member is rotated counterclockwise. The toner images of yellow (Y), magenta (M), cyan (C), and black (K) respectively formed on the surfaces of the four drums 2 are primarily transferred onto the surface of the belt 9 in superposition in the stated order. With this, a toner image of four colors superposed is formed on the surface of the belt 9.

On a right side of an inside of the apparatus main body 101, there is provided a sheet conveyance path 30 through which the sheet S is conveyed from the bottom to the top. In the sheet conveyance path 30, the following components are arranged in order from the bottom to the top: feed roller pairs 13; a registration roller pair 15; a secondary transfer roller 16; a fixing device 19; and a discharge roller pair 20. The secondary transfer roller 16 is arranged so as to be opposed to a belt drive roller 10 on the right side of the intermediate transfer belt unit 8, and is brought into abutment against the belt drive roller 10 through intermediation of the belt 9 with a predetermined pressing force, thereby forming a secondary transfer nip portion 17 between the belt 9 and the secondary transfer roller 16.

The feed roller pair 13 is driven at a predetermined control timing to separate and feed a sheet (recording material, paper) S one by one from the sheet cassette 12 and conveys the sheet S to the sheet conveyance path 30. The sheet S is conveyed to the secondary transfer nip portion 17 at a predetermined control timing by the registration roller pair 15 and is nipped and conveyed in the secondary transfer nip portion 17. As a result, in the secondary transfer nip portion 17, the toner image of four colors superposed on the belt 9 is secondarily transferred onto the sheet S collectively, and an un-fixed toner image is formed on the sheet S.

The sheet S is conveyed from the secondary transfer nip portion 17 to the fixing device 19. The fixing device 19 heats and pressurizes the sheet S to fix the toner image on the sheet S. The sheet S, on which the image is formed, is conveyed from the fixing device 19 to the discharge roller pair 20. The discharge roller pair 20, which serves as a discharge member, discharges the sheet S as an image-formed product onto the discharge tray 21 arranged above the toner bottles 22Y, 22M, 22C, and 22K. The sheet S discharged by the discharge roller pair 20 is stacked on the discharge tray 21, which serves as a stacking portion.

### (Configuration of Discharge Tray Unit)

In the embodiment, a width W of the apparatus main body 101 in a conveying direction CD in which the sheet S is discharged is about 600 mm. As can be seen from FIG. 1, a length of the sheet that can be placed on the discharge tray 21 is about a little more than 400 mm. Meanwhile, as a trend in the image forming apparatus 100 of recent years, there is a demand for adaptability to a variety of materials. It is desired that the image forming apparatus 100 handle feeding of so-called long sheets, for example, sheets each having a length of from about 600 mm to about 1,200 mm in the conveying direction CD. However, as described above, when a length of the discharge tray 21, which is arranged in an in-body space (discharge space) DS of the image forming apparatus 100, is smaller than the length of the long sheet, the long sheet cannot be received on the discharge tray 21 and falls outside the apparatus main body 101. Accordingly, in the embodiment, a discharge tray unit 120, which serves as a discharge unit that enables long sheets to be placed thereon, is mounted to the apparatus main body 101, thereby achieving handling of long sheets.

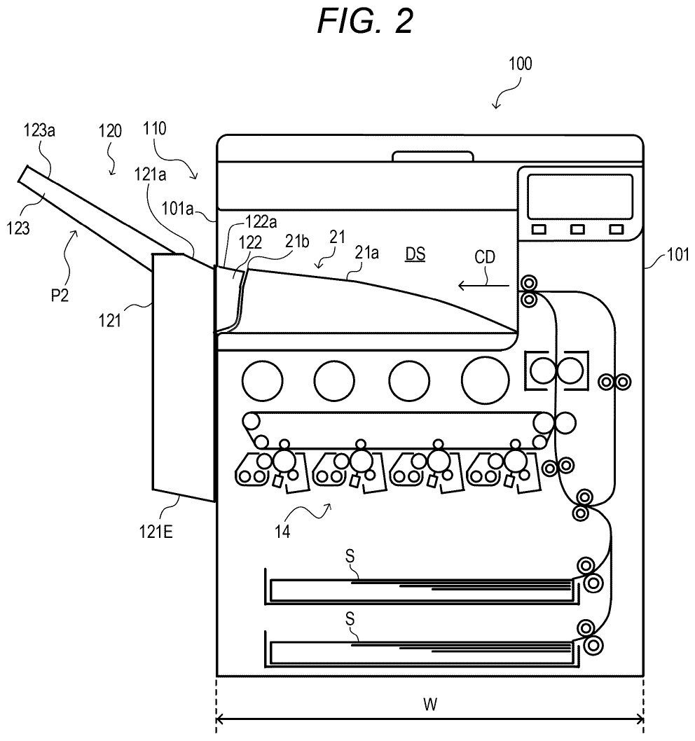

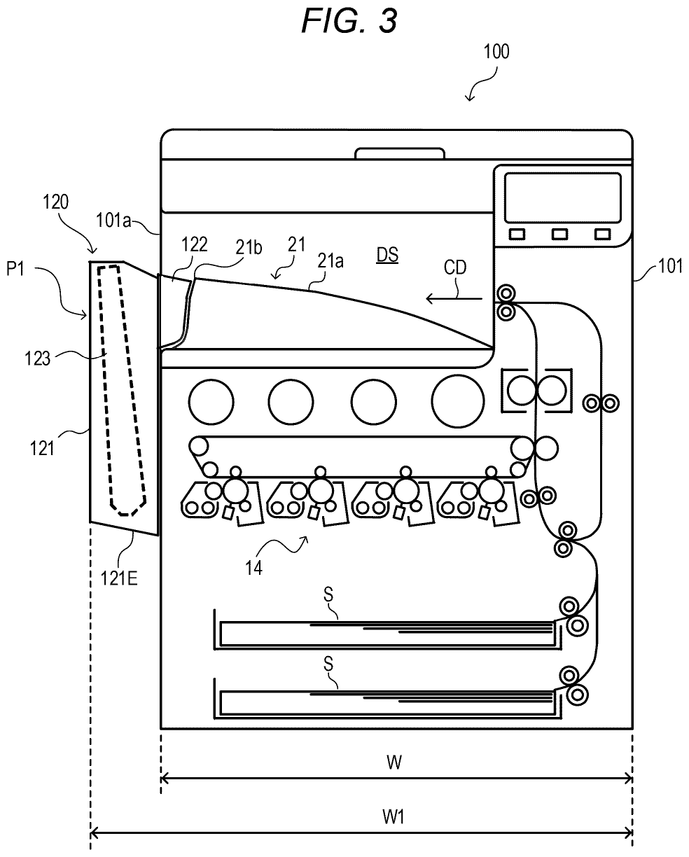

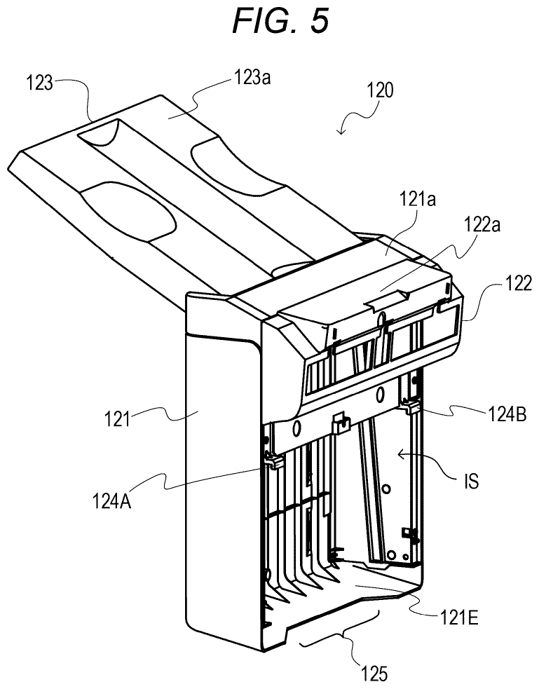

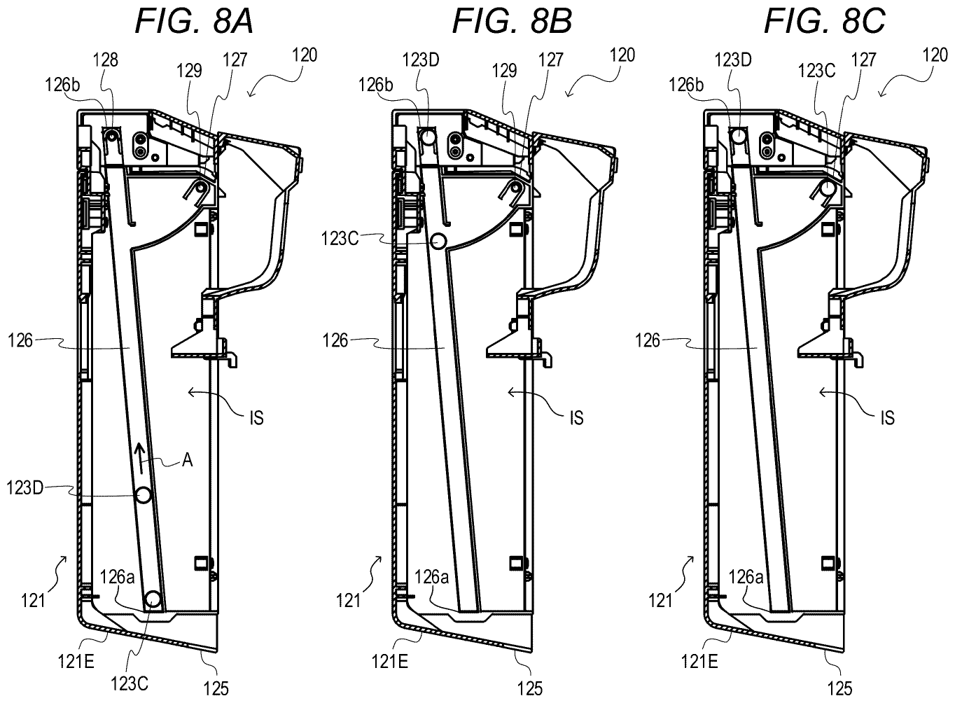

In the following, with reference to FIG. 2 to FIG. 8C, the discharge tray unit 120 in the embodiment is described. FIG. 2 is a sectional view of the image forming apparatus 100 with the discharge tray unit 120 mounted to a left side surface 101a of the image forming apparatus 100. The discharge tray unit 120 includes a placement surface 123a on which the sheet S, on which the image is formed by the image forming portion 14, is placed. The discharge tray unit 120 includes a storage housing 121, a joint portion 122, and an extension tray 123 (tray). The discharge tray 21, the extension tray 123, and the storage housing 121 form a stacking apparatus 110. FIG. 3 is a sectional view of the image forming apparatus 100 with the extension tray 123 stored in the storage housing 121. The storage housing 121 is formed into a box shape having an internal space IS (FIG. 5, FIG. 8A, FIG. 8B, and FIG. 8C) that can store the extension tray 123 (illustrated in FIG. 3 by the broken line) in a substantially vertical posture. The storage housing 121 has a size of sufficient dimensions that are not too large for the extension tray 123.

The extension tray 123 is configured to be sliding-movable and rotatable with respect to the storage housing 121. Thus, the extension tray 123 is movable with respect to the discharge tray 21 of the image forming apparatus 100. The extension tray 123 can take a first state P1 (FIG. 3) in which the extension tray 123 is stored in the storage housing 121 and a second state P2 (FIG. 2) in which the sheet S can be placed on the extension tray 123. The storage housing 121, which serves as a holding portion, is configured to hold the extension tray 123 in the first state P1 and in the second state P2 in which the extension tray 123 can support the sheet S. In the first state P1, the extension tray 123 is stored in the storage housing 121 with the placement surface 123a in a state of a vertical or a state closer to the vertical. The placement surface 123a of the extension tray 123 in the first state P1 is in the state of the vertical or in the state closer to the vertical than the placement surface 123a of the extension tray 123 in the second state P2. The storage housing 121 stores the extension tray 123, which has a small thickness, compactly in a substantially vertical state, and hence, as illustrated in FIG. 3, a width W1 of the image forming apparatus 100 with the discharge tray unit 120 mounted thereto does not become larger than necessary as compared to the width W of the apparatus main body 101. When a long sheet is discharged by the discharge roller pair 20 while the extension tray 123 is in the second state P2, the same sheet as the long sheet stacked on the discharge tray 21 is placed on the placement surface 123a of the extension tray 123.

### (Configuration of Mounting and Removing Discharge Tray Unit)

The discharge tray unit 120 is removably mounted to the apparatus main body 101 of the image forming apparatus 100. When the discharge tray unit 120 is mounted to the apparatus main body 101, the joint portion 122 connects the storage housing 121 to the discharge tray 21 that is arranged in the in-body space DS of the image forming apparatus 100. A placement surface 21a (apparatus-side placement surface) of the discharge tray 21, which receives the discharged sheet S, does not necessarily extend to the left side surface 101a of the apparatus main body 101. A terminal end portion 21b of the discharge tray 21 in the conveying direction CD is often located slightly inward of the left side surface 101a of the apparatus main body 101. The reason for this is due to the design of the discharge tray 21.

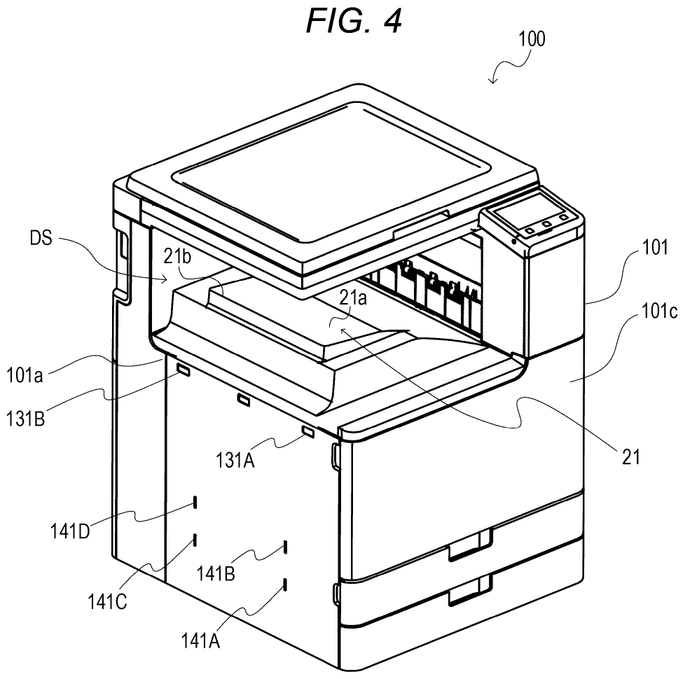

FIG. 4 is a perspective view of the image forming apparatus 100. In the in-body space DS formed in the body of the image forming apparatus 100 as a discharge space, the image forming apparatus 100 is provided with the discharge tray 21 including the placement surface 21a on which the sheet S, on which an image is formed by the image forming portion 14, is to be placed. As illustrated in FIG. 4, the terminal end portion 21b of the discharge tray 21 has an arc-shaped slope, a concave shape, and a convex shape. Accordingly, in order to connect the discharge tray 21 and the discharge tray unit 120 to each other naturally and without difficulty, as illustrated in FIG. 2, the joint portion 122 is used as a junction portion that has a shape complementing to the slope, the concave shape, and the convex shape of the discharge tray 21.

In the embodiment, the joint portion 122 is removably mounted to the storage housing 121. This is because arrangement and dimensions, such as a length and a depth, of the discharge tray 21 may differ depending on types of the image forming apparatus 100. By preparing and replacing a plurality of types of joint portions 122 that correspond to a plurality of types of image forming apparatus 100, respectively, the discharge tray unit 120 can be removably mounted to the plurality of types of image forming apparatus 100.

As illustrated in FIG. 4, engagement holes 131A and 131B (engaged portions) for mounting the discharge tray unit 120 are provided in the left side surface 101a of the apparatus main body 101. FIG. 5 is a perspective view of the discharge tray unit 120. As illustrated in FIG. 5, hooks 124A and 124B (engaging portions) serving as mounting portions are provided on the discharge tray unit 120. The engagement holes 131A and 131B are arranged so as to correspond to the hooks 124A and 124B, respectively. The discharge tray unit 120 is mounted to the apparatus main body 101 by engaging the hooks 124A and 124B with the engagement holes 131A and 131B, respectively. The hooks 124A and 124B are removably mounted to the storage housing 121 in the same manner as in the case of the joint portion 122. This is because positions of the engagement holes 131A and 131B may differ depending on types of the image forming apparatus 100 to which the discharge tray unit 120 is to be mounted. In the same manner as in the case of the joint portion 122, by preparing and replacing a plurality of types of hooks 124A and 124B corresponding to the plurality of types of image forming apparatus 100, respectively, the discharge tray unit 120 can be removably mounted to the plurality of types of image forming apparatus 100.

As illustrated in FIG. 2, in a state in which the extension tray 123 has been pulled out, the placement surface 21a of the discharge tray 21, an upper surface 122a of the joint portion 122, an upper surface 121a of the storage housing 121, and the placement surface 123a of the extension tray 123 form a smooth surface. A length of the smooth surface in the conveying direction CD (discharging direction) may be equal to or larger than 600 mm. When the extension tray 123 is expanded as illustrated in FIG. 2, the extension tray 123 is configured so that a long sheet can be placed on the extension tray 123 and a user can easily access the long sheet placed on the extension tray 123. At coupling positions of the components, an edge of the placement surface of the downstream-side component is lowered by one step in order to prevent a leading edge of the sheet from being caught when the sheet is conveyed along the placement surface. That is, in the conveying direction CD, an upstream-side end portion of the upper surface 122a of the joint portion 122 is lower than a downstream-side end portion of the placement surface 21a of the discharge tray 21. An upstream-side end portion of the upper surface 121a of the storage housing 121 is lower than a downstream-side end portion of the upper surface 122a of the joint portion 122. An upstream-side end portion of the placement surface 123a of the extension tray 123 is lower than a downstream-side end portion of the upper surface 121a of the storage housing 121.

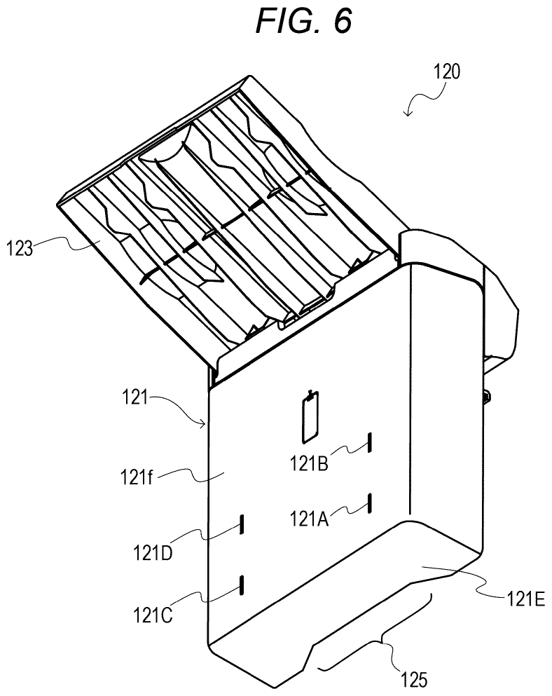

FIG. 6 is a perspective view of the discharge tray unit 120 as seen from an obliquely lower side thereof. As illustrated in FIG. 2, FIG. 3, FIG. 5, and FIG. 6, a bottom surface 121E of the discharge tray unit 120 has a predetermined slope. In the embodiment, the bottom surface 121E of the discharge tray unit 120 is inclined downward towards the left side surface 101a of the image forming apparatus 100. As illustrated in FIG. 5 and FIG. 6, an opening 125 is provided in a lower end portion of the inclined bottom surface 121E as measures for foreign matters falling into the inside of the discharge tray unit 120. For example, foreign matters, such as paper clips or staples, may enter the storage housing 121 through a gap between the storage housing 121 and the extension tray 123 in an upper portion of the discharge tray unit 120. In such cases, the foreign matters fall into the storage housing 121 and reach the bottom surface 121E. The bottom surface 121E is inclined, and hence the foreign matters slide down to the lower end portion of the bottom surface 121E and is discharged out of the discharge tray unit 120 through the opening 125.

### (Configuration of Expanding Extension Tray)

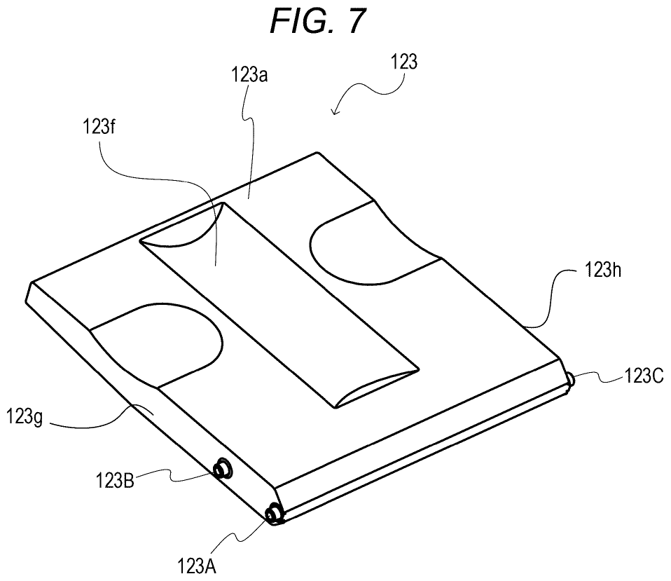

Next, description is given of a configuration in which the extension tray 123 is pulled out of the storage housing 121 and expanded to the second state P2 in which a sheet can be placed on the extension tray 123. FIG. 7 is a perspective view of the extension tray 123. A boss 123A (first engaging portion) and a boss 123B (second engaging portion) are arranged on one side end surface 123g of the extension tray 123, and a boss 123C (first engaging portion) and a boss 123D (second engaging portion, not shown in FIG. 7) are arranged on the other side end surface 123h of the extension tray 123. The boss 123A and the boss 123C are arranged on the both side end surfaces 123g and 123h of the extension tray 123, respectively, so as to correspond to each other in a width direction (direction perpendicular to the conveying direction CD) of the extension tray 123. The boss 123B and the boss 123D (not shown in FIG. 7) are also arranged on the both side end surfaces 123g and 123h of the extension tray 123, respectively, so as to correspond to each other in the width direction.

FIG. 8A, FIG. 8B, and FIG. 8C are sectional views of the discharge tray unit 120. FIG. 8A, FIG. 8B, and FIG. 8C are illustrations of the bosses 123C and 123D of the extension tray 123 as seen through the extension tray 123. On both inner side surfaces of the discharge tray unit 120, there are provided rails (guide portions) 126 that engage with radially outer portions of the bosses 123A, 123B, 123C, and 123D and guide the bosses 123A, 123B, 123C, and 123D in a sliding-movable manner. On one of the inner side surfaces of the discharge tray unit 120, there is provided one rail 126 that engages with the bosses 123A and 123B provided on one side end surface 123g of the extension tray 123. On the other of the inner side surfaces of the discharge tray unit 120, there is provided the other rail 126 that engages with the bosses 123C and 123D provided on the other side end surface 123h of the extension tray 123.

The extension tray 123 is slid and moved out of the storage housing 121 and then rotated, and thus the extension tray 123 changes from the first state P1 (FIG. 3) to the second state P2 (FIG. 2). Expansion accompanied with pulling-out through sliding-movement and rotation of the extension tray 123 is carried out in three stages as illustrated in FIG. 8A, FIG. 8B, and FIG. 8C. First, FIG. 8A is an illustration of a positional relationship between the bosses 123C and 123D and the rail 126 in a state in which the entire extension tray 123 has been stored in the storage housing 121. The bosses 123C and 123D are located at a lower portion of the rail 126. At this time, the own weight of the extension tray 123 causes the boss 123C to come into abutment against a lowermost end portion 126a of the rail 126, and hence the entire extension tray 123 is stored in the storage housing 121. The bosses 123C and 123D are arranged at a predetermined distance, and hence the extension tray 123 is held along the rail 126 without rotating with respect to the rail 126.

Next, FIG. 8B is an illustration of the positional relationship between the bosses 123C and 123D and the rail 126 in a state in which the extension tray 123 has been pulled out to an uppermost position. A snap-fit 128 (FIG. 8A), which is fitted to (engages with) a radially inner portion of the boss 123D, is arranged at an uppermost end portion 126b of the rail 126. When the extension tray 123 is slid and moved upward along the rail 126, the radially inner portion of the boss 123D is fitted to the snap-fit 128 provided at the uppermost end portion 126b of the rail 126. In FIG. 8B, the radially inner portion of the boss 123D has been fitted to the snap-fit 128, and hence centers of the boss 123D and the snap-fit 128 are arranged so as to overlap each other. The snap-fit 128 provides a click feeling when the extension tray 123 is pulled out to the uppermost position, and the click feeling provides recognition that the extension tray 123 has been completely pulled out.

Finally, FIG. 8C is an illustration of the positional relationship between the bosses 123C and 123D and the rail 126 in a state in which the extension tray 123 has been rotated and expanded. The extension tray 123 is rotated counterclockwise about the boss 123D from the state illustrated in FIG. 8B until the boss 123C reaches a snap-fit 129 (FIG. 8B). The snap-fit 129 is arranged immediately before a rib 127 (rotation restricting member) that restricts the rotation of the extension tray 123. The snap-fit 129 provides a click feeling when the extension tray 123 is rotated and a right end portion of the extension tray 123 comes into abutment against the rib 127 so that the extension tray 123 reaches a predetermined expanded position (second state P2). The click feeling provided by the snap-fit 129 provides recognition that the extension tray 123 has reached the predetermined expanded position.

When the extension tray 123 is rotated, fitting between the boss 123D and the snap-fit 128 also functions to hold the extension tray 123 in place so as to prevent the center of rotation from shifting when the extension tray 123 is rotated. In addition, the center of gravity of the extension tray 123 is sufficiently offset to the left. Thus, the right end portion of the extension tray 123 comes into abutment against the rib 127, and this abutment is secured by the own weight of the extension tray 123. The rail 126 and the snap-fit 128 form a support portion that supports the extension tray 123 so that the extension tray 123 is sliding-movable and rotatable.

As described above, by taking the three states illustrated in FIG. 8A, FIG. 8B, and FIG. 8C in sequence, the extension tray 123 can be easily pulled out of the storage housing 121 upward without difficulty, and then expanded through counterclockwise rotation to form a surface on which a long sheet is to be placed. Conversely, when the extension tray 123 is stored into the storage housing 121, by taking the procedure reverse to that illustrated in FIG. 8A, FIG. 8B, and FIG. 8C, the extension tray 123 can be easily stored into the storage housing 121 similarly without difficulty. As illustrated in FIG. 7, a recess 123f is formed in the placement surface 123a of the extension tray 123. When a sheet is placed on the placement surface 123a of the extension tray 123, the recess 123f is used as a gap for catching the sheet with fingers, which improves the ease of removing the sheet.

### (Service Book Holder)

As described above, the discharge tray unit 120 can be mounted to the side surface of the image forming apparatus 100 (in the embodiment, the left side surface 101a of the apparatus main body 101). However, a unit that can be removably mounted to the side surface of the image forming apparatus 100 is not limited to the discharge tray unit 120. For example, a service book holder 130 is conceivable as the unit that can be removably mounted to the side surface of the image forming apparatus 100.

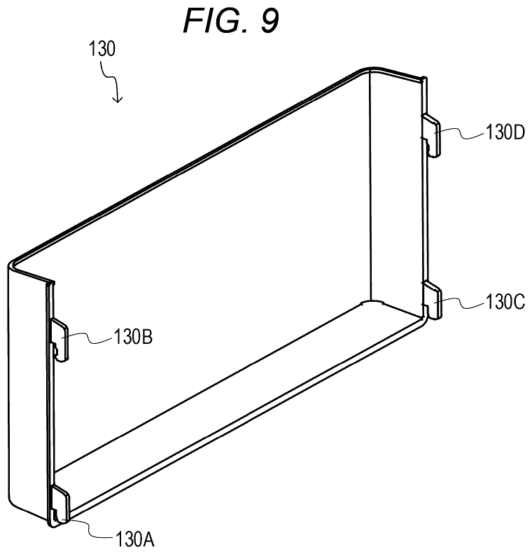

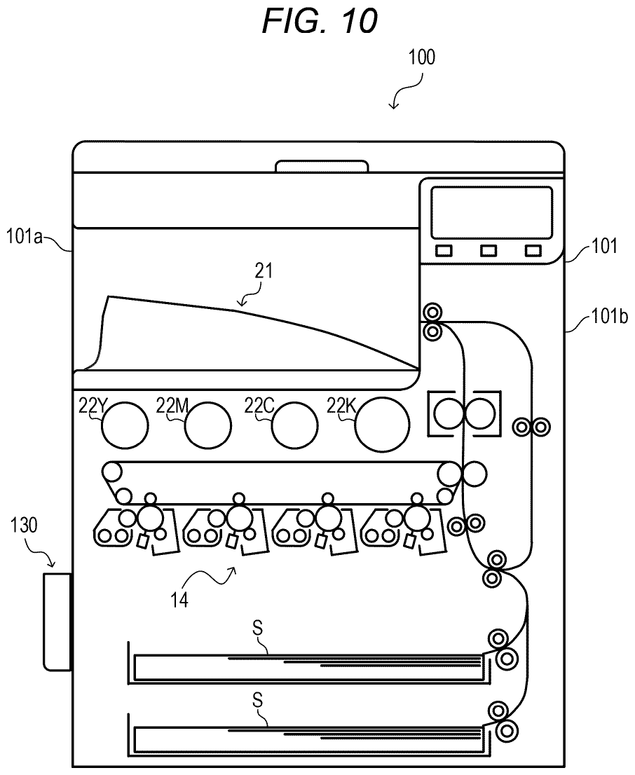

FIG. 9 is a perspective view of the service book holder 130. FIG. 10 is a sectional view of the image forming apparatus 100 to which the service book holder 130 is mounted. As illustrated in FIG. 10, in the same manner as in the case of the discharge tray unit 120, the service book holder 130 is mounted to the left side surface 101a of the apparatus main body 101 of the image forming apparatus 100. The service book holder 130 is a storage container for various manuals such as user manuals. On a right side surface 101b of the apparatus main body 101 of the image forming apparatus 100, there is a door that is opened at the time of clearing a jammed sheet. On a front surface 101c (FIG. 4) of the apparatus main body 101 of the image forming apparatus 100, there is a door that is opened at the time of replacing the toner bottles 22Y, 22M, 22C, and 22K (toner cartridges). Accordingly, it is desired that the service book holder 130 be mounted to the left side surface 101a of the apparatus main body 101. However, it is desired that the discharge tray unit 120 be also arranged, in view of its configuration, on the left side surface 101a of the apparatus main body 101. Accordingly, when no measures are taken, the discharge tray unit 120 and the service book holder 130 are configured to be mounted to the left side surface 101a of the apparatus main body 101 exclusively and selectively.

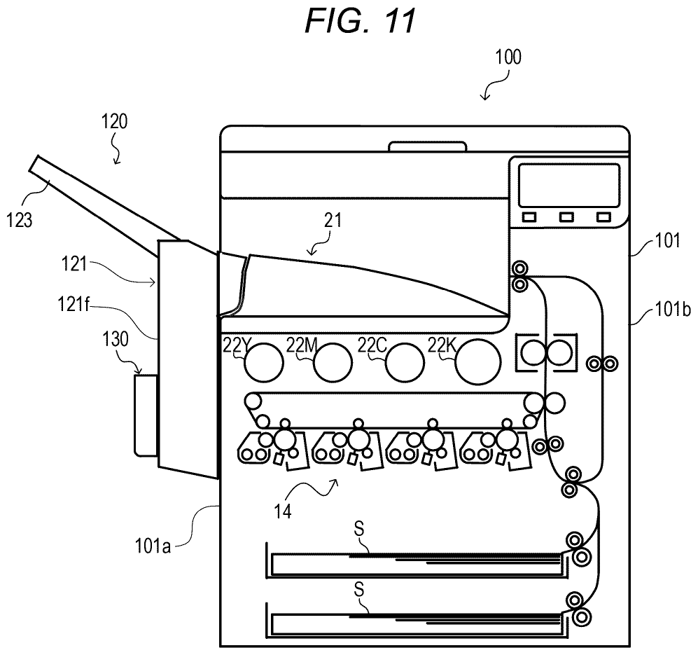

Thus, according to the embodiment, the service book holder 130 is configured to be removably mounted to the discharge tray unit 120. FIG. 11 is a sectional view of the image forming apparatus 100 to which the service book holder 130 and the discharge tray unit 120 are mounted. When the discharge tray unit 120 is mounted to the left side surface 101a of the apparatus main body 101, the service book holder 130 is mounted to a side surface 121f of the storage housing 121 so that the service book holder 130 is mounted on the side of the left side surface 101a together with the discharge tray unit 120. As illustrated in FIG. 6, slits 121A, 121B, 121C, and 121D are provided in the side surface 121f of the storage housing 121. As illustrated in FIG. 9, hook portions 130A, 130B, 130C, and 130D are provided on the service book holder 130. The hook portions 130A, 130B, 130C and 130D of the service book holder 130 are hooked into and fixed to the slits 121A, 121B, 121C and 121D of the storage housing 121. Thus, as illustrated in FIG. 11, the service book holder 130 is removably mounted to the side surface 121f of the storage housing 121 of the discharge tray unit 120.

According to the embodiment, the extension tray 123 can be compactly and easily stored into and pulled out of the storage housing 121 in the state in which the discharge tray unit 120 has been mounted to the image forming apparatus 100. According to the embodiment, it is possible to reduce the time and effort required to mount and remove the extension tray 123, which includes the placement surface 123a on which a sheet is to be placed, and the time and effort required to store the extension tray 123. In addition, the ease of removing a sheet placed on the extension tray 123 is improved.

In the embodiment, the discharge tray unit 120 is removably mounted to the apparatus main body 101 of the image forming apparatus 100 through an engaging unit including the hooks 124A and 124B and the engagement holes 131A and 131B. However, the discharge tray unit 120 is not limited thereto. For example, the discharge tray unit 120 may be fixed to the apparatus main body 101 of the image forming apparatus 100 through a fixing method, such as screw fixing or snap-fitting. The discharge tray unit 120 may be configured so as not to come off easily after being mounted to the image forming apparatus 100. It is only required that the discharge tray unit 120 be mountable to the apparatus main body 101 of the image forming apparatus 100.

In the embodiment, the joint portion 122 and the hooks 124A and 124B are removably mounted to the storage housing 121 and are replaceable. The joint portion 122, the hooks 124A and 124B, and the storage housing 121 are configured separately from each other. However, the joint portion 122 and the hooks 124A and 124B may be configured integrally with each other. Alternatively, the joint portion 122, the hooks 124A and 124B, and the storage housing 121 may be configured integrally with each other. This can reduce the number of parts required for each type of the image forming apparatus 100 and the time and effort required to replace parts. In the embodiment, the image forming apparatus 100 has been described as an LED printer. However, the image forming apparatus 100 is not limited thereto, and may also be a laser printer, an inkjet printer, an electrophotographic copying machine, a multifunction peripheral (MFP), a facsimile apparatus, or a printing machine. The image forming apparatus 100 is not limited to a printer that forms color images and may also be a printer that forms monochrome images.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-150142, filed Sep. 15, 2023, which is hereby incorporated by reference herein in its entirety.

What is claimed is:

1. A stacking apparatus, comprising:
a stacking portion on which a sheet discharged by a discharge member is to be stacked;
a tray including a placement surface on which the same sheet as the sheet stacked on the stacking portion is to be placed, wherein the tray is movable with respect to the stacking portion; and
a holding portion configured to hold the tray in a first state and in a second state in which the tray is able to support the sheet,
wherein the placement surface of the tray in the first state is in a state of a vertical, or in a state closer to the vertical than the placement surface of the tray in the second state.

2. The stacking apparatus according to claim 1, wherein the tray is configured to be sliding-movable and rotatable with respect to the holding portion.

3. The stacking apparatus according to claim 1, wherein the tray is slid and moved out of the holding portion from the first state in which the tray has been stored in the holding portion, and then the tray is rotated to be brought into the second state.

4. The stacking apparatus according to claim 1,
wherein the holding portion includes an inclined bottom surface, and
wherein an opening is formed in a lower end portion of the inclined bottom surface.

5. The stacking apparatus according to claim 1,
wherein the holding portion is configured to be mountable to an image forming apparatus including an image forming portion,
wherein the stacking portion is provided within a discharge space formed in a body of the image forming apparatus, and a sheet, on which an image is formed by the image forming portion, is to be stacked on the stacking portion,
wherein the holding portion includes:
a joint portion configured to couple a placement surface of the stacking portion and the placement surface of the tray to each other; and
a mounting portion configured to mount the holding portion to the image forming apparatus, and
wherein the joint portion and the mounting portion are removably mounted to the holding portion.

6. The stacking apparatus according to claim 5, wherein the holding portion is removably mounted to the image forming apparatus.

7. The stacking apparatus according to claim 5,
wherein the placement surface of the stacking portion, the joint portion, and the placement surface of the tray form a surface on which the sheet is to be placed, and
wherein a length of the surface in a conveying direction for the sheet is equal to or larger than 600 mm.

8. The stacking apparatus according to claim 1,
wherein the tray includes a first engaging portion and a second engaging portion provided on a side portion of the tray in a width direction orthogonal to a direction of discharging the sheet discharged by the discharge member, and
wherein the first engaging portion and the second engaging portion are configured to engage with a guide portion, which is provided in the holding portion, so that the tray is sliding-movable with respect to the holding portion.

9. The stacking apparatus according to claim 8, wherein, when the tray is in the first state, the first engaging portion comes into abutment against a lower end portion of the guide portion.

10. The stacking apparatus according to claim 8, wherein, when the tray is in the first state, the first engaging portion and the second engaging portion are held by the guide portion so as to prevent the tray from rotating.

11. The stacking apparatus according to claim 8, wherein, when the tray is slid and moved upward from the first state and the second engaging portion is positioned at an upper end portion of the guide portion, the tray becomes rotatable about the second engaging portion so as to be brought into the second state.

12. The stacking apparatus according to claim 8, wherein, when the tray is in the second state, the first engaging portion is arranged upstream of the second engaging portion in the discharging direction, and the first engaging portion is held in abutment against the holding portion so that the second state is kept.

13. The stacking apparatus according to claim 8, wherein the first engaging portion and the second engaging portion are provided on each side portion of the tray in the width direction.

14. A stacking apparatus, comprising:
a stacking portion on which a sheet discharged by a discharge member is to be stacked;
a tray including a placement surface on which the same sheet as the sheet stacked on the stacking portion is to be placed, wherein the tray is movable with respect to the stacking portion; and
a support portion configured to support the tray in a sliding-movable and rotatable manner,
wherein the tray is slid and moved from a first state, and then is rotated to be brought into a second state in which the tray is able to support the sheet, and
wherein the placement surface of the tray in the first state is in a state of a vertical, or in a state closer to the vertical than the placement surface of the tray in the second state.

15. The stacking apparatus according to claim 14, further comprising a holding portion that is provided with the support portion and is configured to store the tray in the first state.

16. The stacking apparatus according to claim 15,
wherein the holding portion includes an inclined bottom surface, and
wherein an opening is formed in a lower end portion of the inclined bottom surface.

17. The stacking apparatus according to claim 15,
wherein the holding portion is configured to be mountable to an image forming apparatus including an image forming portion,
wherein the stacking portion is provided within a discharge space formed in a body of the image forming apparatus, and a sheet, on which an image is formed by the image forming portion, is to be stacked on the stacking portion,
wherein the holding portion includes:
a joint portion configured to couple a placement surface of the stacking portion and the placement surface of the tray to each other; and
a mounting portion configured to mount the holding portion to the image forming apparatus, and
wherein the joint portion and the mounting portion are removably mounted to the holding portion.

18. The stacking apparatus according to claim 17,
wherein the placement surface of the stacking portion, the joint portion, and the placement surface of the tray form a surface on which the sheet is to be placed, and
wherein a length of the surface in a conveying direction for the sheet is equal to or larger than 600 mm.

19. The stacking apparatus according to claim 15,
wherein the tray includes a first engaging portion and a second engaging portion provided on a side portion of the tray in a width direction orthogonal to a direction of discharging the sheet discharged by the discharge member, and
wherein the first engaging portion and the second engaging portion are configured to engage with a guide portion, which is provided in the holding portion, so that the tray is sliding-movable with respect to the holding portion.

20. An image forming apparatus comprising:
an image forming portion configured to form an image on a sheet; and
a stacking apparatus including:
a stacking portion on which the sheet, on which the image is formed by the image forming portion and which is discharged by a discharge member, is to be stacked;
a tray including a placement surface on which the same sheet as the sheet stacked on the stacking portion is to be placed, wherein the tray is movable with respect to the stacking portion; and
a holding portion configured to hold the tray in a first state and in a second state in which the tray is able to support the sheet,
wherein the placement surface of the tray in the first state is in a state of a vertical, or in a state closer to the vertical than the placement surface of the tray in the second state.
